(19) United States
(12) Patent Application Publication
(10) Pub. No.: US 2008/0135013 A1
(43) Pub. Date: Jun. 12, 2008

(54) Paddling blades engine

(75) Inventor: Abdalla Aref Adel-Gary, Amman (JO)

Correspondence Address: Abdalla Adel-Gary, Prince Hamza Suburb, P.O. Box 214, Amman, 11733, omitted

(73) Assignee: Abdalla Aref Adel-Gary, Amman (JO)

(21) Appl. No.: 11/594,793

(22) Filed: Nov. 9, 2006

(51) Int. Cl. F02B 55/08

(52) U.S. Cl. 123/243

(57) ABSTRACT

A paddling blades engine comprising two opposing discs (56) rotatably mounted to mount (72), a plurality of blades (58) rotatably mounted to discs (56) with their axis of rotation parallel to the axis of rotation of the discs (56), a mechanical means to maintain the blades (58) parallel to each other and to a non-rotating reference line connecting three and nine o'clock position, a core (68) with its external surface shaped by the traces of the inward edges of blades (58), and a housing (62) with its internal surface shaped by the traces of the outward edges of blades (58) and having intake (63) located between three and six o'clock position and an exhaust (65) located between six and nine o'clock position where discs (56) rotating in a counterclockwise direction. A fuel nozzle (64) and sparkplug (66) are installed on housing (62) at one and twelve o'clock positions respectively. Housing (62) is fastened to mount (72) by covers (24). Power is extracted by shaft (34) gears (30) and internal gears (52).

### BACKGROUND

1. Field of Invention

This invention is an internal combustion engine similar to the gas turbine engine in that it deals with large quantity of air flow, and similar to a reciprocating piston engine in that the blades of the paddling blades engine (PBE) are acted upon and displaced positively by the expanding gases like a piston.

2. Discussion of Prior Art

On one end of the internal combustion engine there are the reciprocating piston and rotary engines, and on the other end there are the turbojet and turboshaft engines. The turbojet and turboshaft engines are characterized by the high power to weight ratio, high fuel consumption and deals with high quantity of air. The piston and the rotary engines are more efficient, lower starting speed and generally made of cheaper materials than the turbojet/turboshaft engines. The piston and the rotary engines require sealing components, such as piston rings that are exposed to high surface velocity and heat and therefore demand proper lubrication. These sealing components are not required in the turbojet and turboshaft engines since leaks constitute a very small percentage of the high quantity of air that passes through these engines.

### SUMMARY

A paddling blades engine comprising a plurality of blades rotatably mounted to two opposing discs in such a way that the axis of rotation of each blade is parallel to the axis of rotation of the discs, a mechanical means to maintain the blades parallel to each other and to a non-rotating reference line connecting three and nine o'clock position, a core with its external surface shaped by the traces of the inward edges of the blades, and a housing with its internal surface shaped by the traces of the outward edges of the blades and said housing having intake located between three and six o'clock position and an exhaust located between six and nine o'clock position where the discs rotating in a counterclockwise direction. A fuel injector and a sparkplug are installed on the housing at one and twelve o'clock positions respectively.

### OBJECTS AND ADVANTAGES

Accordingly, several objects and advantages of my invention are:
(a) to provide rotational power and/or propulsion power.
(b) better thermal efficiency than turbojet/turboshaft engines
(c) it can start at lower rotational speed and deliver higher torque at lower rotational speed than turbojet/turboshaft engine.
(d) it deals with high quantity of air and therefore doesn't require the sealing component to minimize the air leaks such as the ones used in the piston or the rotary engines.
(e) it can be built from cheaper and less exotic materials than those used in the turbojet/turboshaft engine.
(f) it will fill the gap between the piston/rotary engine and the turbojet/turboshaft engine with regards to fuel consumption and power to weight ratio.

### DESCRIPTION OF DRAWINGS

FIG. 1 shows a full exploded view of preferred embodiment of the invention.

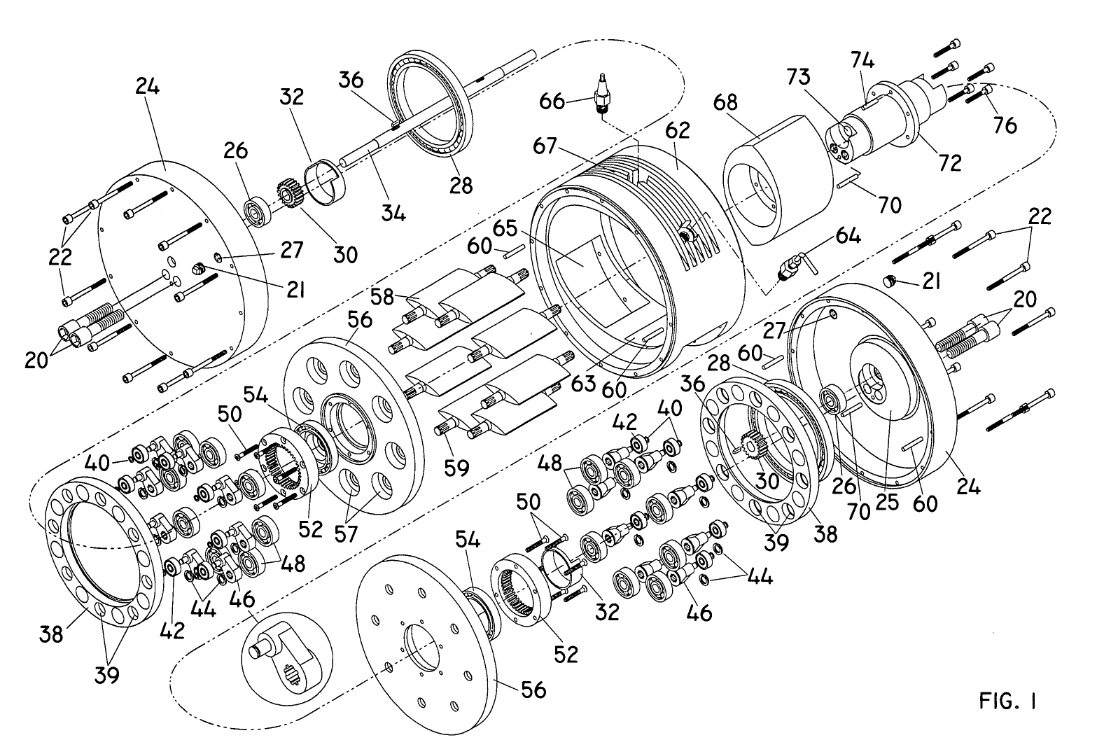

FIG. 2 shows a perspective sectional view of preferred embodiment of the invention where a segment has been sliced off.

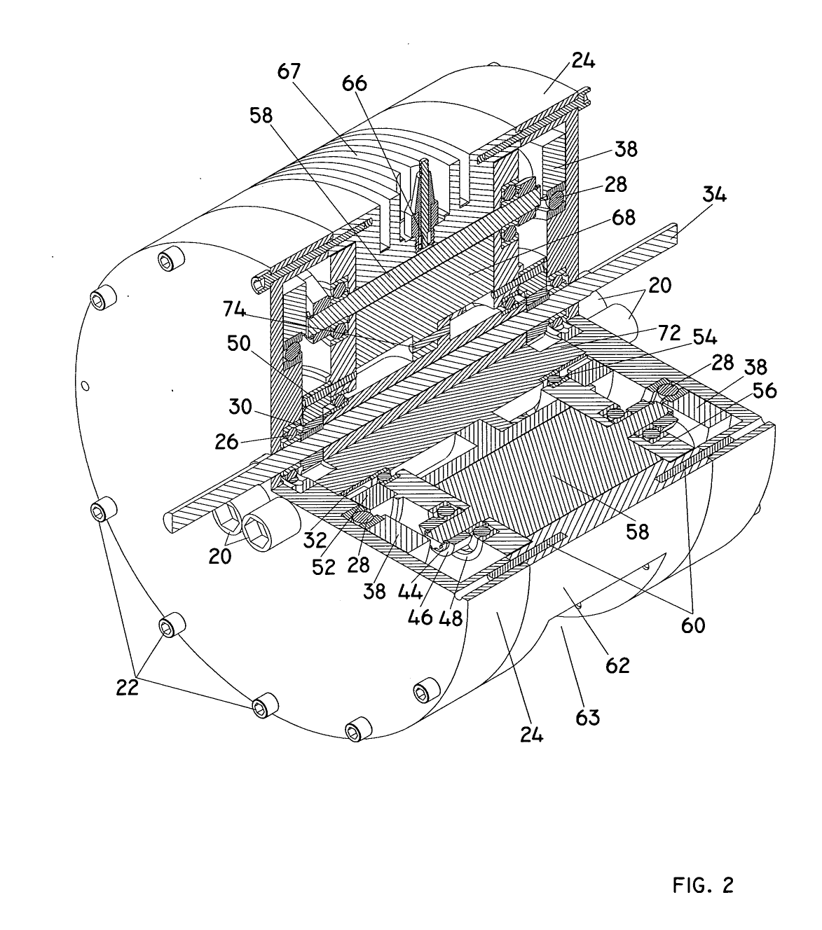

FIG. 3 shows a perspective sectional view of preferred embodiment of the invention that is cut into two halves by a vertical plane.

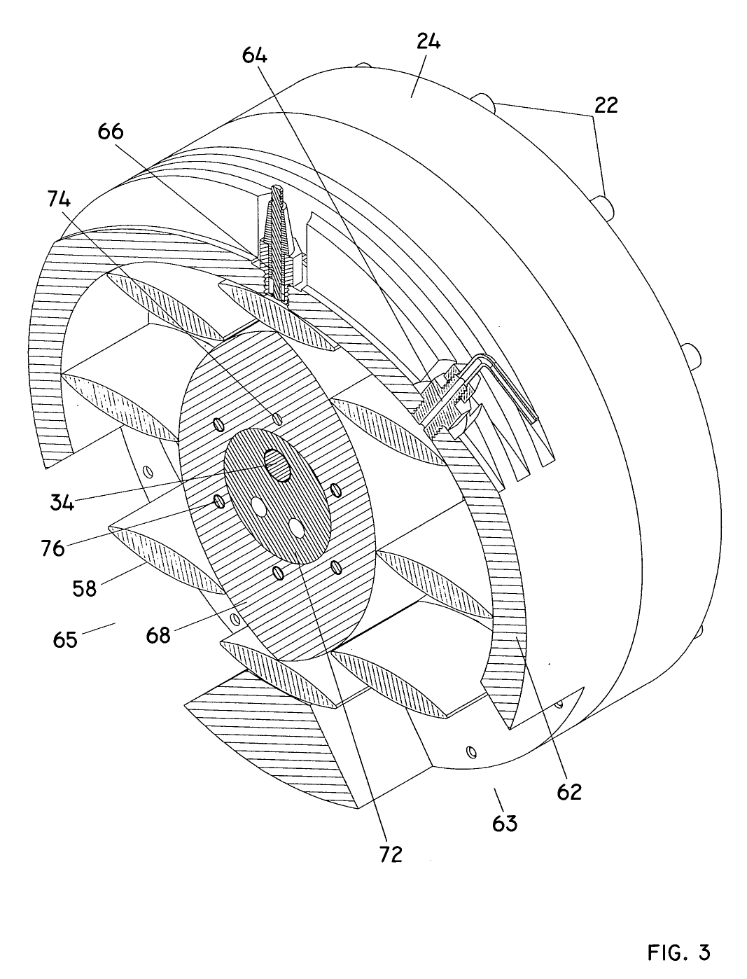

FIG. 4 shows a perspective view of preferred embodiment of the invention where covers have been removed.

FIG. 5 shows the geometry of housing, eye-shaped core and the profile of a blade of the paddling blades engine.

FIG. 6 shows a sectional view of the invention illustrating intake, compression, fuel injection, combustion, expansion, and exhaust regions.

FIG. 7 shows a full exploded view of another embodiment of the invention.

FIG. 8 shows a perspective view of another embodiment of invention where cover and shaft are removed.

### LIST OF REFERENCE NUMERALS OF PREFERRED EMBODIMENT OF INVENTION

20 bolts
21 oil plugs
22 bolts
24 covers
25 eccentric cylindrical protrusion of 24
26 bearings
27 oil fill hole of 24
28 bearings
30 gears
32 sliding rings
34 shaft
36 Keys
38 rings
39 holes of 38
40 snap rings
42 bearings
44 snap rings
46 levers
48 bearings
50 screws
52 internal gears
54 bearings
56 discs
57 holes of 56
58 blades
59 splined ends of 58
60 guide pins
62 housing
63 inlet of 62
64 fuel nozzle
65 outlet of 62
66 sparkplug
67 cooling vanes of 62
68 eye-shaped core
70 guide pins
72 mount
73 hole of 72
74 guide pin
76 bolts

### LIST OF REFERENCE NUMERALS OF ANOTHER EMBODIMENT OF INVENTION

80 bolts
82 oil plug
84 cover
85 cylindrical protrusion of 84
86 key
87 oil fill hole of 84
88 non-rotating gear
89 key way of 88
90 snap rings
91 grove of 85
92 snap rings
94 bearings
96 middle gears
98 studs
100 snap rings
102 blade gears
104 snap rings
106 bearings
108 spacers
110 disc
111 holes of 110
112 holes of 110
113 hole of 110
114 bearings
116 spacer
118 snap ring
120 shaft
122 screws
124 blades
125 splined ends of 124
126 guide pins
128 housing
129 inlet of 128
130 eye-shaped core of 128
131 outlet of 128
132 cooling vanes of 128
134 fuel nozzle
136 sparkplug

### DESCRIPTION OF PREFERRED EMBODIMENT OF INVENTION

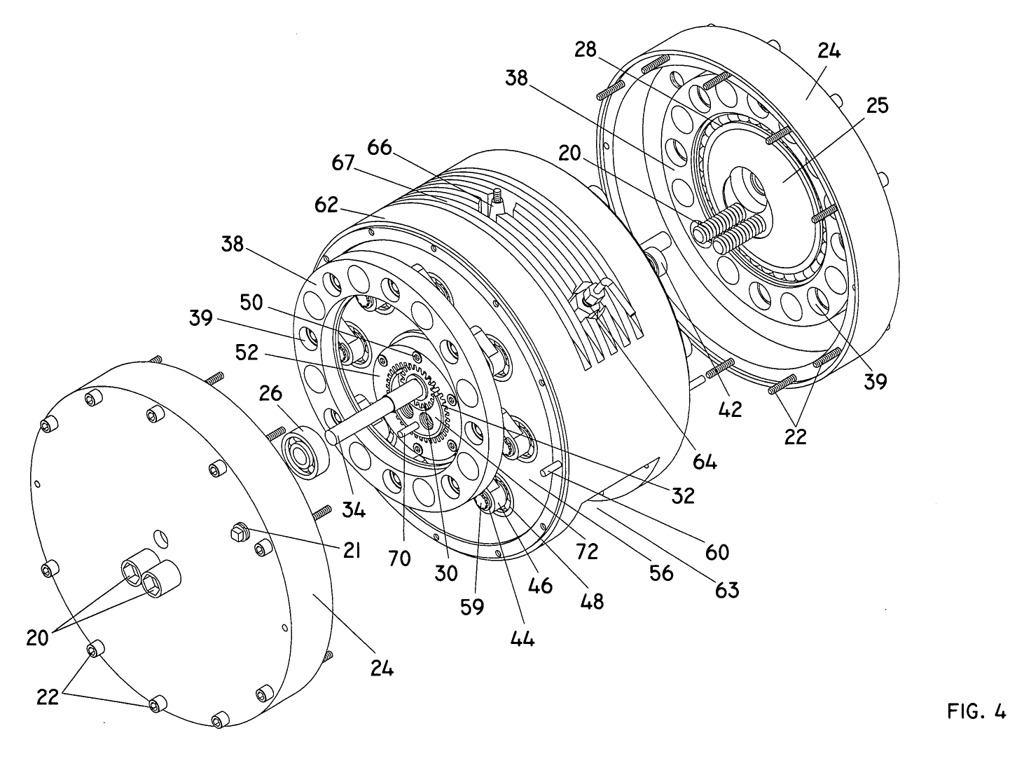

The paddling blades engine comprises of mount 72 that is attached to an eye-shaped core 68 by means of a guide pin 74 and five bolts 76. The mount 72, the eye-shaped core 68 and eight blades 58 are placed inside housing 62 and all sandwiched by two discs 56. Each blade 58 is mounted to the discs 56 by means of two bearings 48 that set in holes 57. The two discs 56 are supported to the mount 72 by means of two bearings 54 that are fastened to ends of mount 72 by means of sliding rings 32. Each bearing 54 is fastened to the disc 56 by internal gear 52 and six screws 50. Shaft 34 is inserted into hole 73. Two gears 30 are coupled to shaft 34 by keys 36 and meshed with internal gears 52 one on each side, see FIG. 4.

Attached to each blade 58 are two levers 46, one on each side. The levers 46 make an angle 45° to the blades 58 and an angle 90° to opposite levers 46. The levers 46 are coupled to the blades 58 by means of the splined end 59 and snap rings 44. Bearings 42 are attached to levers 46 by snap rings 40. The eight bearings 42, on each side, are inserted into holes 39 of ring 38. Bearings 28 are fitted to the rings 38. A bearing 26, two guide pins 60, and a guide pin 70, are inserted into each cover 24. Covers 24 are placed on each side of housing 62 so that each bearing 28 sets on the eccentric cylindrical protrusion 25 of covers 24. An oil plug 21 is installed on each cover 24. Each cover 24 is fastened to the mount 72 by two bolts 20 and fastened to the housing 62 by ten bolts 22. Fuel nozzle 64 and sparkplug 66 are installed on the housing 62.

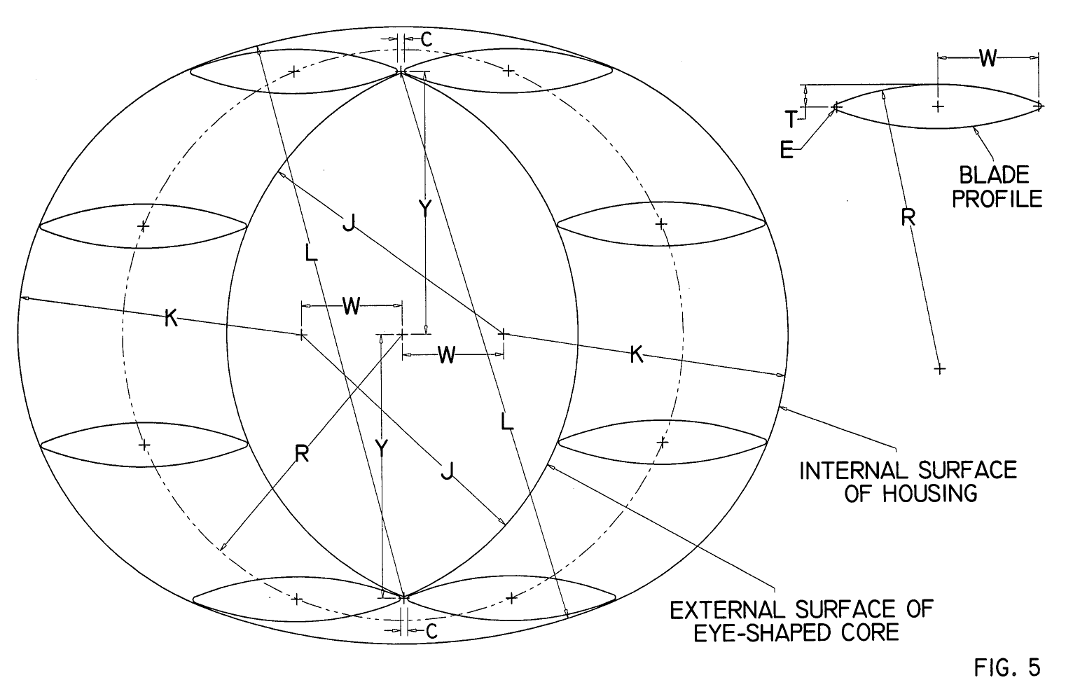

FIG. 5 shows the geometry of the internal surface of housing 62, external surface of eye-shaped core 68 and the profile of blade 58. First, the radius of the orbit R, which is the distance between the axis of rotation of discs 56 and the axis of rotation of blades 58, is determined. The radius R is a measure of the size of the PBE. Second, the number of the blades N is determined. The higher the number of the blades the higher the compression ratio. There are practical limitations on high number of blades. The geometry shown in FIG. 5 can be found from the following equations:

W=R sin(π/N)−E−½C,

where E: is the radius of edge of the blade 58,

C: is the clearance between the blades 58 when in line.

T=R−[(R−E)²−W²]^{1/2}.

K=R+E+G.

J=R−E−G.

Where G: is the clearance between blades 58 and housing 62, and eye-shaped core 68, not shown in FIG. 5.

Y=[W²−(T−E)²]/2(T−E).

L=(Y²+W²)^{1/2}+K.

### OPERATION OF PREFERRED EMBODIMENT OF INVENTION

Rotating shaft 34 counterclockwise rotate gears 30. Gears 30 rotate internal gears 52 thus rotating the two discs 56 counterclockwise. The rotation of discs 56 makes the eight blades 58 orbit the axis of rotation of discs 56. The eight levers 46, which are coupled to the left splined ends 59 of blades 58, rotate the left ring 38 about the center of the left eccentric cylindrical protrusion 25. This center is shifted to the left and up by an angle of 45°, from the axis of rotation of the discs 56, and shifted a distance equal to the lever 46 arm. And the eight levers 46, which are coupled to the right splined ends 59 of blades 58, rotate the right ring 38 about the center of the right eccentric cylindrical protrusion 25. This center is shifted to the right and up by an angle of 45°, from the axis of rotation of the discs 56, and shifted a distance equal to the lever 46 arm. The levers 46 and the rings 38 maintain the blades 58 parallel to each other and to a non-rotating reference line while moving in a circular orbit around the axis of rotation of discs 56. The motion of a blade 58 is similar to the motion of a foot paddle of a bicycle, where it moves in a circular orbit while staying parallel to the ground. By this motion, the air chambers, which are confined by adjacent blades 58, the housing 62, the eye-shaped core 68, and the discs 56, change volume cyclically.

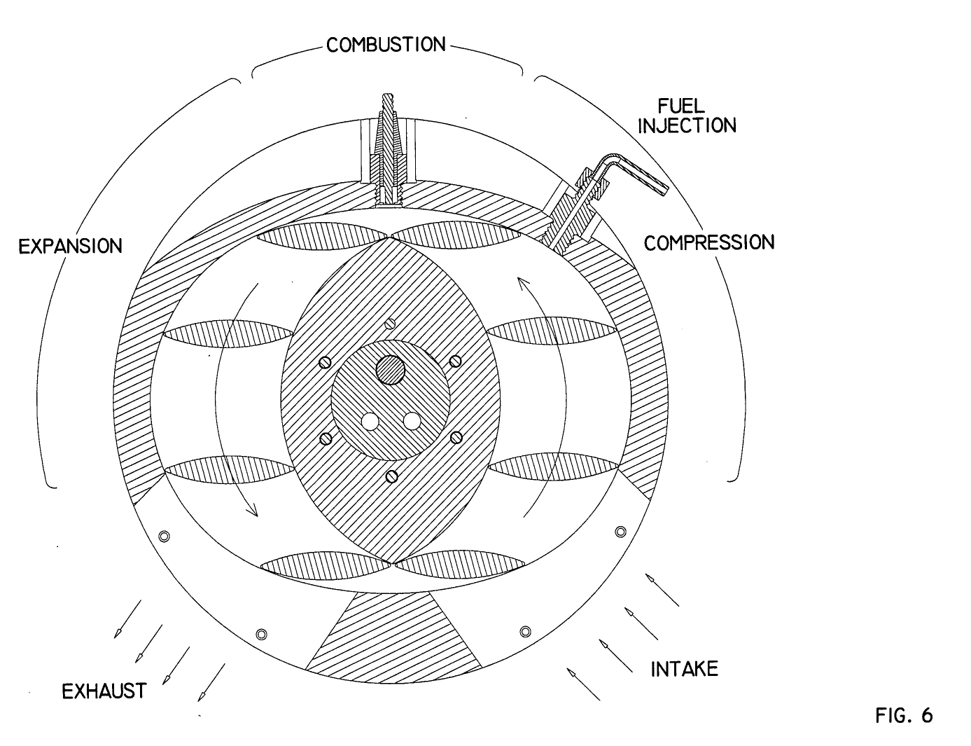

First air enters the PBE through the inlet 63, air is then compressed, see FIG. 6, fuel is injected, then combustion and expansion, and exhaust through outlet 65. In the expansion stage, where the pressure is high, the hot gases act by a force on the forward blade 58 in the direction of motion, and act by an opposite force on the rear blade 58. The force on the forward blade results in a larger torque on the discs 56 than the opposing force on the rear blade. This is because the angle between the normal to the blade and the tangent to the discs 56 at the forward blade is smaller than that at the rear blade. This net torque on the discs 56 will accelerate the engine and enable it to deliver a net power to shaft 34. As the PBE accelerate, more fuel is injected until the PBE reaches its maximum designed rotational speed and/or maximum designed gas temperature.

The PBE can run on different kinds of fuel. For fuel such as gasoline, sparkplug 66 should ignite when the fuel air mixture is compressed the most. This corresponds to when the upper two blades are inline, see FIG. 6. At high rotational speed sparkplug 66 should ignite earlier, while at starting or low speed sparkplug 66 should ignite later. This is similar to advancing the ignition of piston engine at high rotational speed. For jet or diesel fuel, the ignition of sparkplug 66 (igniter) should be continuous.

The PBE dissipate the heat through cooling vanes 67, which increase the area exposed to cool air. The lubrication of bearings 26, 28,42, 48 and 54, and gears 52 and 30 is accomplished by oil which is partially filled in the cavity between covers 24 and discs 56 through oil fill hole 27. The lubrication oil helps in cooling discs 56, and also in cooling bearings 26, 28, 42, 48 and 54, and gears 52 and 30. The blades 58 do not require any lubrication since they don't touch or rub the housing 62, the eye-shaped core 68 and/or the discs 56.

The PBE can be used to deliver propulsion (jet) power since it deals with high quantity of airflow similar to a conventional jet engine. In addition, the PBE will permit gas temperature that is double of that of turbine inlet temperature of conventional turbojet engine. This is because the blades 58, which are the critical component that will determine the maximum allowable temperature, like the turbine blade in a jet engine, spend half their time in cold air and therefore stabilizes at an average temperature which will be about half of that of the combusted gas temperature. The PBE will have a good thermal efficiency in comparison with turbojet and turboshaft engines. Furthermore, the PBE will have a good power to weight ratio since higher gas temperature will permit more fuel burning. Another advantage of the PBE over the turbojet and turboshaft engines is that it can start at much lower speed. Since the slightest increase in pressure due to combustion will result in a net torque on the discs 56. This is because blades 58 are acted upon positively, like a piston, by the combusted gases, and leaks from the clearances between the blades 58 and the housing 62, the eye-shaped core 68, and the discs 56, can be made minimal.

### DESCRIPTION AND OPERATION OF ANOTHER EMBODIMENT OF INVENTION

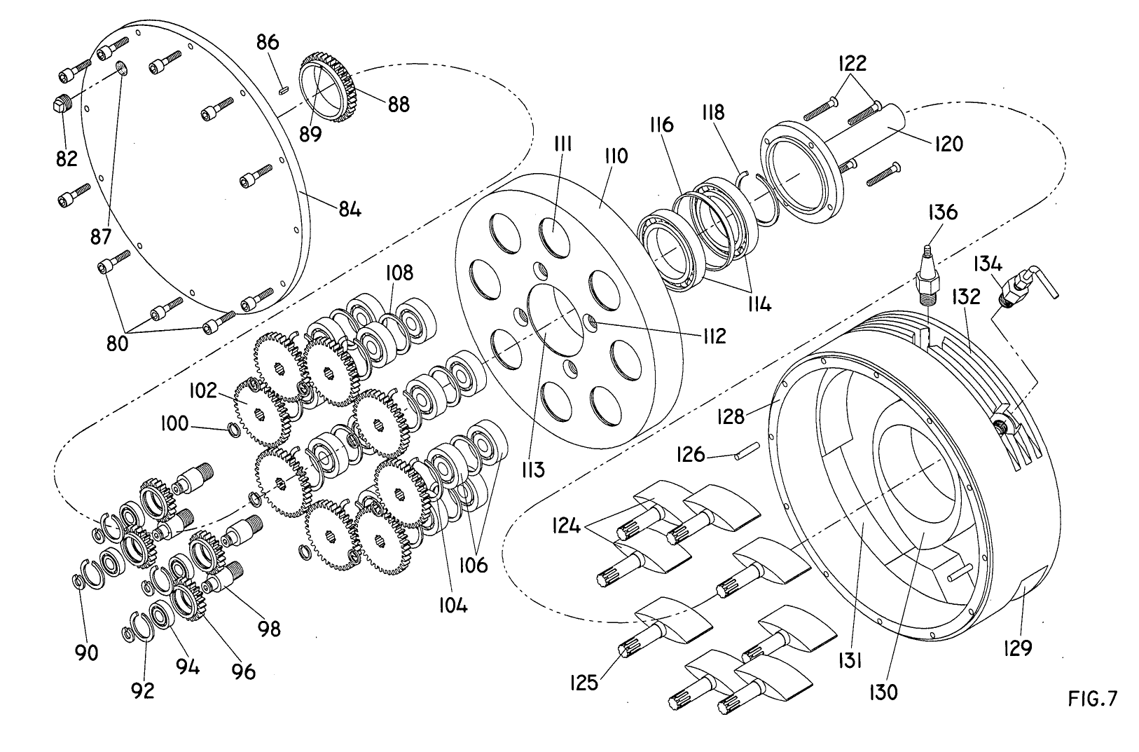

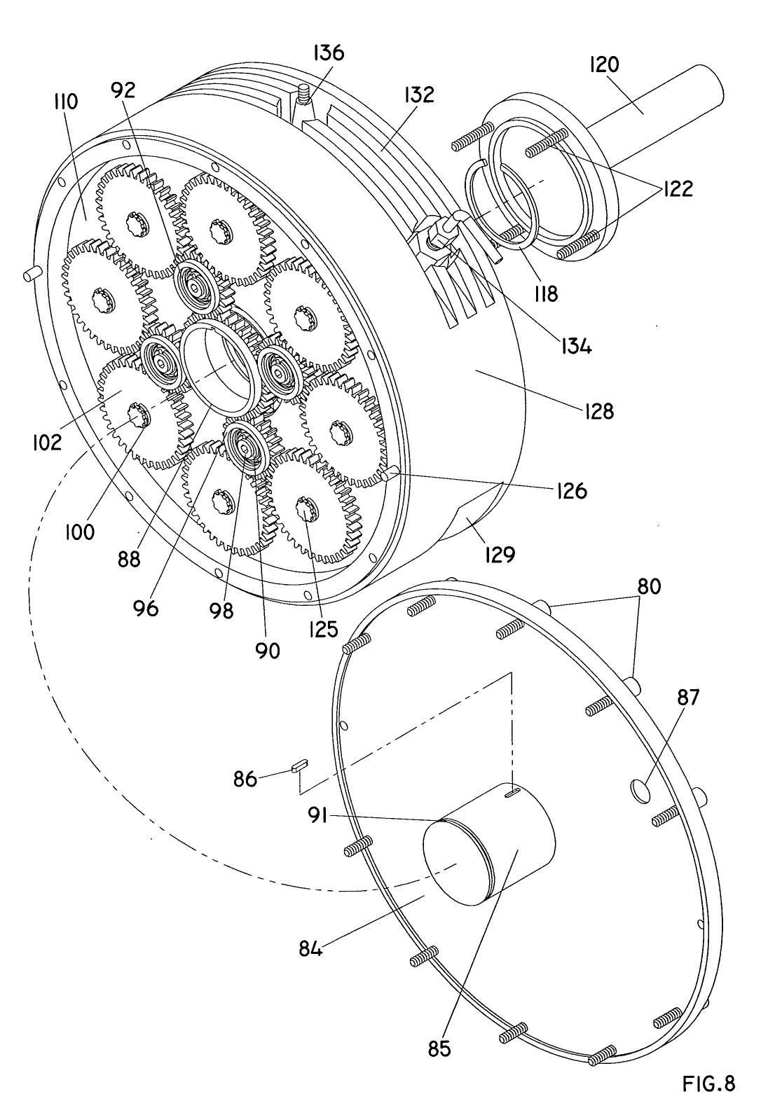

Another embodiment of the paddling blades engine, see FIG. 7 and FIG. 8, comprises of eight blades 124 that are rotatably mounted to disc 110. Each blade 124 is mounted to disc 110 by means of two bearings 106 and a spacer 108. Bearings 106 and spacer 108 fit into hole 111 and secured in place by snap ring 104. A blade gear 102 is coupled to each blade 124 by means of its splined ends 125. The blade gear 102 and bearings 106 are secured to blade 124 by snap ring 100. Every two blade gears 102 are meshed with a middle gear 96. Each middle gear 96 is mounted to disc 110 by means of bearing 94, snap ring 92, snap ring 90, and a stud 98 that is screwed into hole 112. A non-rotating gear 88 is meshed with middle gears 96 while blades 124 are parallel to each other and perpendicular to a reference line connecting the center of non-rotating gear 88 and its key way 89. The non-rotating gear 88 is coupled to cylindrical protrusion 85 by key 86 and key way 89, see FIG. 8. Disc 110 is mounted to cylindrical protrusion 85 by two bearings 114 and a spacer 116. Bearings 114 and spacer 116 are secured to cylindrical protrusion 85 by snap ring 118 which fits groove 91. Shaft 120 is coupled to disc 110 by four screws 122 that are screwed into taped holes in disc 110, not shown. Shaft 120 also secure bearings 114 and spacer 116 inside hole 113. Housing 128 is attached to cover 84 by ten bolts 80 and two guide pins 126. Oil plug 82 is fitted to oil fill hole 87. Fuel nozzle 134 and sparkplug 136 are fitted to housing 128.

The geometry of the internal surface of housing 128 and the external surface of its eye-shaped core 130 and the profile of blade 124 is the same as the preferred embodiment of PBE, which is shown in FIG. 5.

For the operation, rotating shaft 120 will rotate disc 110, which make gears 102 and gears 96 orbit the non-rotating gear 88. This will cause blades 124 to orbit, in a counterclockwise direction, the axis of rotation of disc 110 while staying parallel to each other and to a non-rotating reference line. As a result, air enters through inlet 129, air is then compressed, see FIG. 6, then fuel is injected, followed by combustion, expansion, and exhaust through outlet 131. The rest of the operation is the same as the preferred embodiment.

While the above description contains many specifications, these should not be construed as limitations on the scope of the invention, but as exemplifications of the presently preferred embodiments thereof. Many other ramifications and variations are possible within the teachings of the invention.

For example, levers 46 and rings 38, or gears, 102, 96 and 88, can be replaced by an infinite number of system of gears and/or sprocket and chain system that connect between the splined ends 59/125, and the covers 24/84, or mount 72, so as to keep blades 58/124 parallel to each other and to a non-rotating reference line while moving in a circular orbit.

The profile of the blade 58/124 can be made flat and not necessarily follow the geometry given in description of the invention. The mount 72 and the eye-shaped core 68 can be made into one part.

The cooling vanes 67/132 can be replaced by coolant passages inside the housing 62/128 and inside the eye-shaped core 68/130. The discs 56/110 and rings 38 can be equipped with a system of passages for transferring lubricants and for cooling bearings 48, 42, and 106. The inlet 63/129 and the outlet 65/131 can be equipped with intake ducts and exhaust nozzle, respectively, to direct the exhaust jet of gases.

The location of sparkplug 66/136 can be different. In some cases, where the PBE runs at very high rotational speed, and/or the fuel burning is slow, and/or the number of blades is high, advancing the timing of ignition might not be enough as the spark moves to the forward chamber. In such cases sparkplug location needs to be moved, for example to one o'clock position, in a direction opposite to the rotation. Or have the PBE equipped with more than one sparkplug; one sparkplug at two o'clock for high speed operation, one at twelve o'clock for medium speed operation, and one at ten o'clock for starting and slow speed operation.

The location of the fuel nozzle can be different also. In some cases, where the PBE runs on jet or diesel fuel, more fuel burning, in the early stages of expansion, might be required. In such cases, the fuel nozzle and the sparkplug (igniter) locations are moved, for example to twelve and eleven o'clock respectively, forward in the direction of rotation. Or have the PBE equipped with two or more fuel nozzles and igniters; one fuel nozzle and igniter at one and twelve o'clock position respectively, and one fuel nozzle and igniter at twelve and eleven o'clock respectively. Further variations are possible, the fuel nozzles can be installed on the eye-shaped core 68/130 and direct the jet of fuel to igniters or to flame holders that can be installed inside recesses in the housing 62/128.

The dimension of the PBE along the axis of shaft 34/120 can be made larger than the diameter of the housing 62/128. The PBE can be made of two or more assemblies, similar to the preferred embodiment, assembled together with one shaft. Where the blades 58 are long and mounted to discs 56 at their ends and supported by a disc or more in between, and housing 62 is long and is made of two halves, upper and lower or right and left. Or the PBE is made of two assemblies similar to the other embodiment where the blades are rotatably mounted to one disc from their middle and encased by two opposing housings 128.

Thus the scope of the invention should be determined by the appended claims and their legal equivalents, and not by the examples given.

I claim:

1. A paddling blades engine comprising:
(a) two rotary members having one axis of rotation and each having a surface substantially perpendicular to their axis of rotation and their surfaces opposing each other,
(b) a plurality of substantially non twisted blades rotatably mounted by means of both of their ends to said two rotary members in such a way that the axis of rotation of each said blade is substantially parallel to the axis of rotation of said two rotary members, and said plurality of blades evenly distributed at an equal distance from the axis of rotation of said two rotary members,
(c) a mechanical means connected to at least one of the ends of each said plurality of blades to maintain said plurality of blades parallel to each other and to a non-rotating reference line while moving in a circular orbit about the axis of rotation of said two rotary members,
(d) a housing incasing said plurality of blades having its internal surface shaped by the traces of the outward edges of said plurality of blades, and said housing having an inlet opening for the entry of air located substantially between three and six o'clock position and an outlet opening for the exhaust of hot gases located substantially between six and nine o'clock position where said plurality of blades are substantially parallel to a line connecting the three and the nine o'clock position and where said two rotary members rotating in a counterclockwise direction,
(e) a core placed between said two rotary members and surrounded by said plurality of blades, and said core having its external surface shaped by the traces of the inward edges of said plurality of blades, thereby resulting in air chambers, that change volume cyclically, confined by the surfaces of adjacent said plurality of blades, the surfaces of said two rotary members, the internal surface of said housing, and the external surface of said core,
(f) means for fastening said housing to said core,
(g) means to introduce fuel into said air chambers,
(h) means to ignite fuel and air mixture substantially between ten and two o'clock position, whereby resulting in a net torque in the counterclockwise direction on said two rotary members, and resulting in a jet of hot gases coming out of the outlet opening of said housing.

2. The paddling blades engine of claim 1, further including means for transferring rotational power from at least one of said two rotary members.

3. The paddling blades engine of claim 1 wherein said two rotary members are mounted to said core.

4. The paddling blades engine of claim 1 wherein said two rotary members are mounted to said means for fastening said housing to said core.

5. The paddling blades engine of claim 1 wherein said plurality of blades are substantially rectangular in shape.

6. The paddling blades engine of claim 1 wherein said plurality of blades having a profile substantially composed of two opposing arcs.

7. The paddling blades engine of claim 1 wherein said fuel ignition means comprises a recess forming a combustion chamber for retaining a device selected from the group consisting of a sparkplug and an igniter.

8. The paddling blades engine of claim 1 wherein said fuel introduction means comprises a device selected from the group consisting of a fuel injector and fuel nozzle.

9. The paddling blades engine of claim 1 further including means for lubricating and cooling frictionally mated moving surfaces of all aforementioned components.

10. The paddling blades engine of claim 1 further including means for cooling all heated aforementioned components.

11. A paddling blades engine comprising:
(a) a rotary member having at least one surface substantially perpendicular to its axis of rotation,
(b) a plurality of substantially non twisted blades rotatably mounted to said rotary member in such a way that the axis of rotation of each said blade is substantially parallel to the axis of rotation of said rotary member, and said plurality of blades evenly distributed at an equal distance from the axis of rotation of said rotary member,
(c) a mechanical means connected to said plurality of blades to maintain said plurality of blades parallel to each other and to a non-rotating reference line while moving in a circular orbit about the axis of rotation of said rotary member,
(d) a housing incasing said plurality of blades having its internal and side surfaces shaped by the traces of the outward edges and ends, respectively, of said plurality of blades, and said housing having a core surrounded by said plurality of blades, and the core of said housing having its external surface shaped by the traces of the inward edges of said plurality of blades, thereby resulting in air chambers, that change volume cyclically, confined by the surfaces of adjacent said plurality of blades, the surface of said rotary member, the internal and side surfaces of said housing, and the external surface of the core of said housing, and said housing further having an inlet opening for the entry of air located substantially between three and six o'clock position, and an outlet opening for the exhaust of hot gases located substantially between six and nine o'clock position, where said plurality of blades substantially parallel to a line connecting the three and the nine o'clock position, and where said rotary member rotating in a counterclockwise direction,
(e) means to mount said rotary member to said housing,
(f) means to introduce fuel into said air chambers,
(g) means to ignite fuel and air mixture substantially between ten and two o'clock position, whereby resulting in a net torque in the counterclockwise direction on said rotary member, and resulting in a jet of hot gases coming out of the outlet opening of said housing.

12. The paddling blades engine of claim 11 further including a means for transferring rotational power from said rotary member.

13. The paddling blades engine of claim 11 wherein said plurality of blades are substantially rectangular in shape.

14. The paddling blades engine of claim 11 wherein said plurality of blades having a profile substantially composed of two opposing arcs.

15. The paddling blades engine of claim 11 wherein said fuel ignition means comprises a recess forming a combustion chamber for retaining a device selected from the group consisting of a sparkplug and an igniter.

16. The paddling blades engine of claim 11 wherein said fuel introduction means comprises a device selected from the group consisting of a fuel injector and fuel nozzle.

17. The paddling blades engine of claim 11 further including means for lubricating and cooling frictionally mated moving surfaces of all aforementioned components.

18. The paddling blades engine of claim 11 further including means for cooling all heated aforementioned components.

19. The paddling blades engine of claim 11 wherein said plurality of blades mounted to said rotary member by means of one of their ends.

20. The paddling blades engine of claim 11 wherein said mechanical means connected to one of the ends of said plurality of blades.
